(19) United States
(12) Patent Application Publication
(10) Pub. No.: US 2015/0379317 A1
(43) Pub. Date: Dec. 31, 2015

(54) Tracking Transactions By Confluences of RFID Signals

(71) Applicant: Amazon Technologies, Inc., Reno, NV (US)

(72) Inventors: Justin David Kelly, Seattle, WA (US); Ryan Scott Russell, Bellevue, WA (US)

(21) Appl. No.: 14/314,419

(22) Filed: Jun. 25, 2014

(51) Int. Cl. G06K 7/10; G06Q 10/08

(52) U.S. Cl. CPC G06K 7/10366; G06Q 10/087

(57) ABSTRACT

Where an RFID reader receives multiple RFID signals at the same time, or at nearly the same time, from multiple RFID tags, a transaction may be defined. Information regarding the transaction may be stored in at least one data store. The multiple RFID tags may be associated with one or more objects, humans, machines or structures, and the information regarding the transaction may include times or dates at which the RFID signals were received, or the identities of the objects, humans, machines or structures with which the RFID tags were associated. At least one of the RFID signals may be received from a manually activated RFID tag, which may transmit the RFID signal within the presence of an RFID reader only upon contact.

### BACKGROUND

Online marketplaces frequently maintain inventories of items in one or more storage or distribution facilities, which are sometimes called fulfillment centers. Such facilities may include stations for receiving shipments of items, stations for storing such items, and/or stations for preparing such items for delivery to customers. For example, when a vendor delivers an inbound shipment of items to a fulfillment center, the shipment may arrive at a receiving station, where the items included in the shipment may be removed from the containers in which they arrived and transported to one or more storage areas within the fulfillment center by human workers or machines (e.g., one or more autonomous mobile robots). Likewise, when an online marketplace receives an order for one or more items from a customer, the items may be retrieved from their respective storage areas within the fulfillment center and transported to a distribution station, where the items may be prepared for delivery to the customer in an appropriate container with a suitable amount or type of dunnage, also by one or more machines or workers. Alternatively, where demand for an item already exists at a time when the item arrives at the fulfillment center, the item may be transported directly from the receiving station to the distribution station, or “cross-docked,” for prompt delivery to the customer.

Thus, a lifecycle of an item within a fulfillment center may be defined based on the various interactions between the item and one or more objects, humans, machines or structures in various locations. A status of the item within the fulfillment center may be determined based on whether, where and how recently a machine or a worker has interacted with an item, which may be referenced in terms of one or more transactions. For example, one transaction involving an item may occur when a worker removes a container including the item from a truck or other carrier arriving at a receiving station, while another transaction may occur when a worker removes the item from the container. Still other transactions may occur when a worker stows the item in a predetermined region of a storage area, retrieves the item from the predetermined storage region or transports the item to a destination station.

Obtaining information regarding the various transactions occurring during a lifecycle of an item is not always a simple task. For example, in a fulfillment center environment that may include hundreds of thousands or even millions of items, identifying a worker or machine that placed an item in a particular storage bin at a given time or was responsible for transporting the item to a particular station is occasionally difficult. Where an item is missing, misplaced or damaged, reconstructing the events which led to such conditions with specificity, including the times at which such events occurred or the individuals associated with such events, may be quite challenging.

### BRIEF DESCRIPTION OF THE DRAWINGS

FIG. 1 is a view of one system for tracking transactions by confluences of RFID signals, in accordance with embodiments of the present disclosure.

FIG. 2 is a block diagram of components of one system for tracking transactions by confluences of RFID signals, in accordance with embodiments of the present disclosure.

FIG. 3 is a flow chart of one process for tracking transactions by confluences of RFID signals, in accordance with embodiments of the present disclosure.

FIGS. 4A and 4B are views of one system for tracking transactions by confluences of RFID signals, in accordance with embodiments of the present disclosure.

FIG. 5 is a flow chart of one process for tracking transactions by confluences of RFID signals, in accordance with embodiments of the present disclosure.

FIGS. 6A and 6B are views of one system for tracking transactions by confluences of RFID signals, in accordance with embodiments of the present disclosure.

FIG. 7 is a flow chart of one process for tracking transactions by confluences of RFID signals, in accordance with embodiments of the present disclosure.

FIGS. 8A and 8B are views of one system for tracking transactions by confluences of RFID signals, in accordance with embodiments of the present disclosure.

FIGS. 9A and 9B are views of one system for tracking transactions by confluences of RFID signals, in accordance with embodiments of the present disclosure.

### DETAILED DESCRIPTION

As is set forth in greater detail below, the present disclosure is directed to the tracking of transactions or occurrences based on detected or observed commonalities, or confluences, of signals received from two or more radio frequency identification (or “RFID”) tags or sources associated with various entities, e.g., objects, humans, machines or structures. Specifically, the systems and methods disclosed herein are directed to simultaneously or nearly simultaneously capturing signals from a predetermined number of RFID tags, including an RFID tag associated with a worker or an autonomous mobile robot, an RFID tag associated with an item or an RFID tag associated with a given location, and capturing and storing information regarding a transaction or occurrence based on a confluence of such signals.

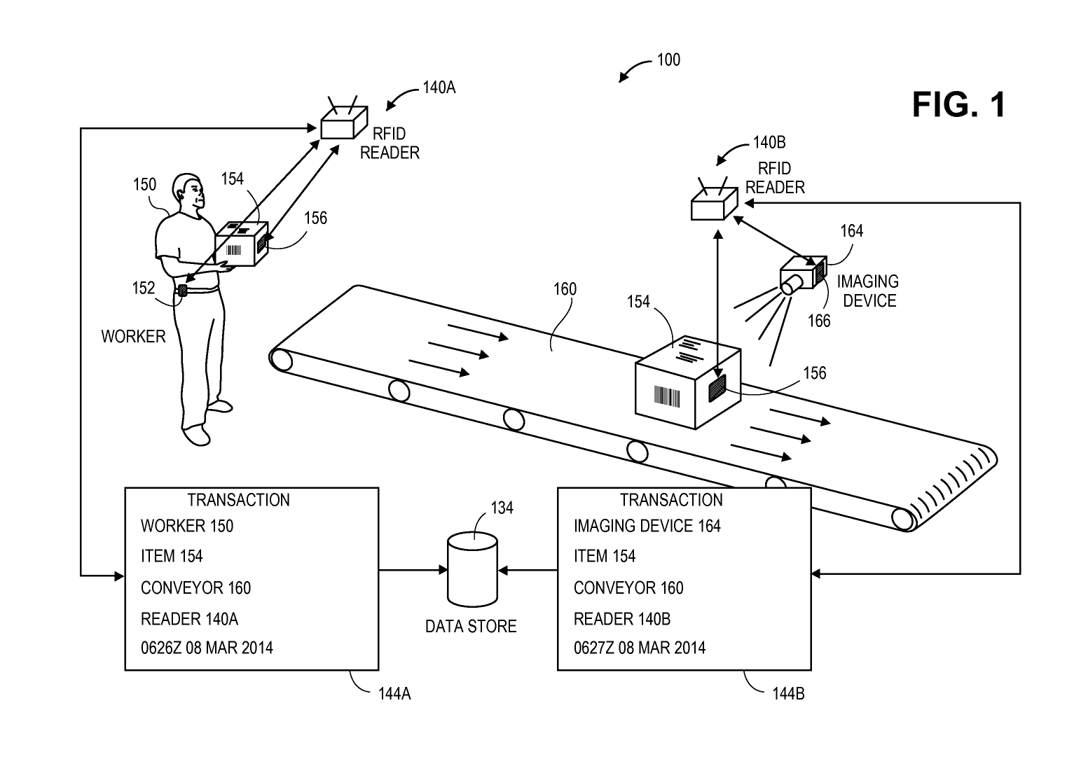

Referring to FIG. 1, a system 100 for tracking transactions by confluences of RFID signals is shown. The system 100 includes a database 134, a pair of RFID readers 140A, 140B, a worker 150, a conveyor 160 and an imaging device 164. The RFID readers 140A, 140B are mounted in fixed locations with respect to the conveyor 160. As is shown in FIG. 1, the worker 150 is preparing to place an item 154 onto the conveyor 160. The worker 150 is wearing an RFID tag 152 about his or her waist, e.g., on a belt, an apron, a workbelt or another article of clothing. The item 154 has an RFID tag 156 mounted thereto, e.g., taped, fastened, glued or otherwise embedded to a surface of the item 154 or a container thereof. Similarly, the imaging device 164 has an RFID tag 166 mounted thereto.

According to the systems and methods disclosed herein, information regarding one or more transactions may be recorded upon recognizing a predetermined confluence of RFID signals by an RFID reader. As is shown in FIG. 1, when signals are received by the RFID reader 140A from both the RFID tag 152 of the worker 150 and the RFID tag 156 on the item 154, information regarding a transaction, viz., a data packet 144A identifying the worker 150 and the item 154, or the RFID tags 152, 156, as well as dates and times when such signals were received, and the RFID reader 140A at which such signals were received, is transmitted to the database 134, where such information may be processed and/or stored. Similarly, when the item 154 travels to within a vicinity of the imaging device 164, and signals are received by the RFID reader 140B from both the RFID tag 156 of the item 154 and the RFID tag 166 on the imaging device 164, similar information regarding a transaction, viz., a data packet 144B, is transmitted from the RFID reader 140B to the database 134, where such information may be processed and/or stored.

By capturing and storing information associated with the simultaneous or nearly simultaneous receipt of signals, e.g., the receipt of signals at the same time or within a predetermined time interval, from one or more predetermined combinations of RFID tags, the systems and methods of the present disclosure enable more accurate and efficient recording and auditing of information regarding physical and virtual transactions involving objects, humans, machines or structures. Specifically, as is shown in FIG. 1, based on the confluence of RFID signals received from the RFID tag 152 of the worker 150, and the RFID tag 156 of the item 154, the database 134 will include information 144A indicating a date and time at which the worker 150 deposited the item 154 onto the conveyor 160. As is also shown in FIG. 1, the database 134 will further include information 144B indicating a date and time at which the item 154 arrived within a vicinity of the imaging device 164 on the conveyor 160. Such information may be utilized in real time or in near-real time to update a status of the item 154, e.g., to indicate that the item 154 has arrived at the conveyor 160, that the item 154 has been placed onto the conveyor 160, that the item 154 has been photographed by the imaging device 164, or that the item 154 is in any other state. Additionally, such information may be further reviewed or audited at a later time, in order to identify key events associated with the lifecycle of the item 154 which occurred within the system 100, including the identities of the worker 150 who placed the item 154 onto the conveyor 160, or the imaging device 164 which photographed the item 154, and the dates and times when such interactions occurred.

Alternatively, the systems and methods of the present disclosure may further capture and store information regarding one or more physical and virtual transactions involving objects, humans, machines or structures based on a failure to detect a confluence of RFID signals as expected, or based on detecting a confluence of RFID signals other than a confluence that had been anticipated. For example, where an item bearing an RFID tag is expected to arrive at a point or to pass within a range of an RFID reader at a given time, and a predefined confluence of one or more RFID signals, including an RFID signal transmitted from the RFID tag, is not detected or observed within a predetermined interval of the given time, it may be inferred that the item has neither arrived at the point nor passed within the range of the RFID reader as scheduled, and that a transaction involving the item has failed to occur. Similarly, where it is expected that a predefined confluence of RFID signals will be received by one or more RFID readers at a given time, and a confluence of RFID signals other than the predefined confluence of RFID signals is received instead, it may be further inferred that at least one fault associated with an intended transaction has been encountered.

RFID refers to a wireless, non-contacting system for transferring data by way of radio frequency electromagnetic fields. In an RFID system, data transfers occur in the form of modulated signals transmitted between an RFID tag, which may include various communication components, logic or circuitry, and an RFID reader, which may include antennas or other like devices. Data stored within a microchip or other storage device associated with the RFID tag may be sent to the RFID reader, which may interpret not only the data received in the RFID signal but also other relevant information or attributes of the RFID signal, such as an intensity or a frequency of the RFID signal, as well as a direction from which the RFID signal originated, a range traveled by the RFID signal or at least some of the information or data included in the RFID signal. The transfer of the RFID signal is initiated when an electric field or a magnetic field transmitted by an RFID reader is sensed by an RFID tag, which transmits information or data that may be stored in association with the RFID tag in one or more microchips or other storage devices.

RFID systems provide a number of advantages over similar systems for the short-range transfer of information or data. First, an RFID tag may be formed of components having remarkably small, compact shapes and sizes, and tags that are as thin as a sheet of paper or smaller than a grain of rice are quite common. Additionally, unlike a bar code (e.g., a one-dimensional bar code or a two-dimensional “QR” code), an RFID tag need not be provided within a line of sight of an RFID reader in order to successfully transmit data. Therefore, RFID tags may be concealed or embedded into many different types of objects of any size or shape, as well as humans or other animals. Next, an RFID tag may be programmed with a fixed set or packet of “read-only” data which may be transmitted to an RFID reader countless number of times in theory, or reprogrammed with modifiable sets of data that may be written and rewritten, as needed, based on the application in which the RFID tag is provided. Moreover, and perhaps most importantly, while an active RFID tag includes and utilizes a local power source, such as a battery, a passive RFID tag does not require any power in order to successfully transmit a set or packet of data to an RFID reader, and may therefore transmit such data when power supplies are unavailable or in environments where providing power to the RFID tag is infeasible.

RFID signals may be transmitted from an RFID tag to an RFID reader in many different formats and at many different frequency levels. An RFID tag that transmits signals within low frequency (LF), medium frequency (MF) or high frequency (HF) levels (e.g., approximately 3 kilohertz to 30 megahertz, or 3 kHz-30 MHz) may transfer relatively small-sized sets or packets of data over short ranges (e.g., between one and one hundred centimeters, or 1-100 cm). Other RFID tags may transmit signals at higher frequency levels, such as ultrahigh frequency (UHF) or microwave levels (e.g., approximately 300 megahertz to 300 gigahertz, or 300 MHz-300 GHz) including larger sets or packets of data at ranges of one meter (1 m) or longer.

A signal transmission from an RFID tag to an RFID reader may be achieved in any number of ways. An inductively coupled RFID tag is an RFID tag that is powered by energy obtained from magnetic fields generated by an RFID reader, and may be coupled to the RFID reader using this energy. In this regard, an RFID reader may include one or more coils through which an electric current may pass, thereby causing a magnetic field to be generated by the RFID reader according to Ampere's Law. Likewise, an inductively coupled RFID tag may also include one or more coils. When the RFID tag passes within a particular range of the RFID reader, an electric current is generated within the coils of the RFID tag, thereby coupling the RFID reader and the RFID tag based on the magnetic flux passing through the respective sets of coils. The electric current passing through the coils of the RFID tag may then power internal circuits within the RFID tag, and cause an RFID signal to be transmitted from the RFID tag to the RFID reader accordingly. Thus, inductively coupled RFID tags are commonly used in powerless environments where a passive system for transmitting signals may be required.

Additionally, an RFID tag may be coupled by any number of other modes. For example, capacitively coupled RFID tags include coupling plates that are designed to correspond to a plate of an RFID reader. When the RFID tag is placed in sufficiently close proximity to the RFID reader, thereby causing the corresponding coupling plates of the RFID tag and the RFID reader to be aligned in parallel with one another and within a short range, a transfer of data from the RFID tag to the RFID reader is achieved. Unlike an inductively coupled RFID tag, which is powered by a magnetic field generated by an RFID reader, a capacitively coupled RFID tag is powered by an alternating electric field generated by an RFID reader. For this reason, capacitively coupled RFID tags usually have more limited operating ranges than inductively coupled RFID tags and are typically employed in near-field communication environments. Similarly, a backscatter-coupled RFID tag receives power emitted from an RFID reader's antenna. A portion of the emissions from the RFID reader are received by a corresponding antenna of the RFID tag and may be filtered or rectified, as necessary, in order to trigger a transfer of data from the RFID tag to the RFID reader. Any type or mode of coupling between an active, semi-active (e.g., powered on a temporary basis or for limited purposes) or passive RFID tag and an RFID reader may be utilized in accordance with the present disclosure.

In addition to RFID tags which are automatically coupled with an RFID reader, the systems and methods of the present disclosure may further include an RFID tag, such as a passive RFID tag, which may be manually activated, e.g., coupled upon a manual action, by a human or machine in order to cause a transmission of a data signal from the RFID tag to one or more RFID readers. A manually activated RFID tag may include physical or virtual switches that may close a circuit within the RFID tag and thereby permit the RFID tag to function as a data transmitter in the presence of an electric or magnetic field. For example, a manually activated RFID tag may include capacitive elements that define a capacitor within the RFID tag, and may effectively close a circuit within the RFID tag when such elements detect bioelectricity from a user. The term “bioelectricity” generally refers to electrical charges or electric field gradients that may be stored within a living body, such as a human body, which contains blood and other matter having a variety of positively and negatively charged ions (e.g., sodium, chloride and others). Bioelectricity within a body may cause a change in capacitance of such elements in a vicinity of a location touched by the body (e.g., a digit such as a finger or thumb), due to disruptions in electrical fields caused by the body's presence, thereby further causing a change in the time constant of the RFID tag, and a discharge of the capacitor in an amount that may be defined as a function of the resistance of the capacitive elements.

According to some embodiments, such capacitive elements may be formed into a layered stack, beginning first with a protective layer of plastic or other suitable materials. The protective layer may be adhered to one or more capacitive elements of an RFID circuit, which may include elements formed from a conductive material such as aluminum, copper, silicon or indium tin oxide that are separated by an air gap. When a user touches the protective layer with a finger, which is a bioelectric conductor, a change in the effective capacitance (on the order of approximately one picofarad) between the elements, which are also conductors, in a vicinity of a point or points of contact with the protective layer is introduced. Such contact forms a conductive bridge across the elements, thereby causing disruptions in electrical fields in the vicinity of one or more of the elements, and further causing an internal current flow through the RFID tag circuit.

In addition to capacitive elements, a circuit of an RFID tag may include other components for enabling a manual actuation thereof by a human or a machine, including one or more substantially planar conductive elements that may be separated by an air gap. Such an air gap between the conductive elements defines an open switch within the circuit of the RFID tag, which may be covered with a flexible protective layer that may be formed from one or more flexible plastics or rubbers (e.g., acrylics, vinyls, polyurethanes or the like), or other like materials. When a user contacts an external surface of the RFID tag corresponding to the air gap, e.g., the flexible protective layer over the air gap, at least two of the conductive elements are placed in contact with one another, thereby bridging the air gap between the conductive elements and closing the open switch. Subsequently, an internal current flow through the RFID tag circuit is enabled. Because the bridging of the air gap and the closure of the open switch is registered by manually driven electrical contact, a manually activated RFID tag including substantially planar conductive elements does not require bioelectricity in order to operate properly, and a user may interact with the RFID tag using not only his or her fingers or hands (which may be gloved or ungloved) but also a stylus, a pointer or another like object.

The systems and methods of the present disclosure are directed to receiving RFID signals from multiple RFID tags on a simultaneous or nearly simultaneous basis, e.g., at the same time, or within a predetermined time interval of one another, and capturing and storing information regarding the simultaneous or nearly simultaneous capture of such signals in at least one data store. More particularly, the systems and methods of the present disclosure are directed to recognizing a predetermined confluence of RFID signals transmitted by multiple RFID tags at one or more RFID readers, determining that a transaction has occurred based on the recognition of the predetermined confluence, and transmitting and/or storing information regarding the transaction. Such RFID tags may be mounted to, embedded in or otherwise associated with one or more objects, humans, machines or structures, including but not limited to such objects, humans, machines or structures within a fulfillment center environment, or also worn or carried by a worker or an autonomous mobile robot within such an environment.

Additionally, the predetermined confluences of RFID signals may be defined in advance based on RFID tags associated with specific objects, humans, machines or structures, or signals transmitted by such objects, humans, machines or structures, as well as categories of such objects, humans, machines or structures. For example, a transaction may be recorded when RFID signals are received from an RFID tag on a specific worker or autonomous mobile robot, from an RFID tag on a specific item and from an RFID tag on a specific machine, such as the tags 152, 156, 166 on the worker 150, the item 154 or the imaging device 164 of FIG. 1, or when RFID signals are received from RFID tags associated with workers, items or machines of a given type or group. Moreover, the predetermined confluences may be defined based at least in part on the collection of signals from RFID tags that are sufficiently close to one another, which may be further determined based on attributes of the RFID signals such as a maximum angular or radial separation of directions or ranges of such signals, matched intensities or strengths of such signals, or information or data included in such signals.

Where a predetermined confluence of RFID signals has been defined based on a particular combination of RFID tags associated with specific objects, humans, machines or structures, and the predetermined confluence of RFID signals is not detected or observed as scheduled, or where a different confluence of RFID signals is detected or observed, a transaction may be deemed to have failed to occur, and information regarding the failed transaction may be stored in at least one data store. For example, referring again to FIG. 1, if a confluence of signals including a signal from the RFID tag 152 on the worker 150 and a signal from the RFID tag 156 on the item 154 is not detected by the RFID reader 140A when expected, then information regarding a failure of either the worker 150 or the item 154 to arrive within a vicinity of the RFID reader 140A as scheduled may be captured and stored. Alternatively, if a confluence of signals that is different than that which was expected, e.g., a confluence including a signal from the RFID tag 152 on the worker and a signal from an RFID tag on an item other than the item 154 (not shown), or a confluence including a signal from an RFID tag on a worker (not shown) other than the worker 150 and a signal from the RFID tag 156 on the item 154, is detected by the RFID reader 140A, information regarding the confluence of signals that was detected, and/or a failure to detect the expected confluence of signals, may be captured and stored.

In this regard, by exploiting the efficiency of RFID systems to quickly and effectively transmit and receive data signals transmitted from an RFID tag within a vicinity of an RFID reader, the systems and methods of the present disclosure may enhance the capacity of computer-based systems associated with networks of one or more RFID readers to capture and store information regarding transactions between objects, humans, machines or structures bearing RFID tags. The systems and methods disclosed herein may therefore capture and store information regarding a transaction characterized by the simultaneous or nearly simultaneous receipt of RFID signals from predetermined RFID tags, and only when such signals are received, thereby minimizing the amount or extent of data that need be captured and stored in order to verify that the transaction has occurred, and also increasing the quality and relevance of the captured and stored information. Conversely, the systems and methods disclosed herein may also capture and store information regarding a failure of an intended transaction to occur as scheduled, or regarding an occurrence of a transaction other than the intended transaction, in order to subsequently determine why the intended transaction did not occur.

Once information regarding a plurality of transactions has been captured and stored in accordance with the present disclosure, the information may be used for any purpose. For example, the information may be used to determine or update a real time or near-real time status of an object, e.g., an item arriving at a fulfillment center, such as the item 154 in the system 100 of FIG. 1. Alternatively, the information may be used at a later time to identify, evaluate or audit one or more additional events or occurrences associated with the item, or to identify one or more entities associated with such events or occurrences, or dates or times at which such events or occurrences happened, thereby resulting in an enhanced level of quality of service and accountability.

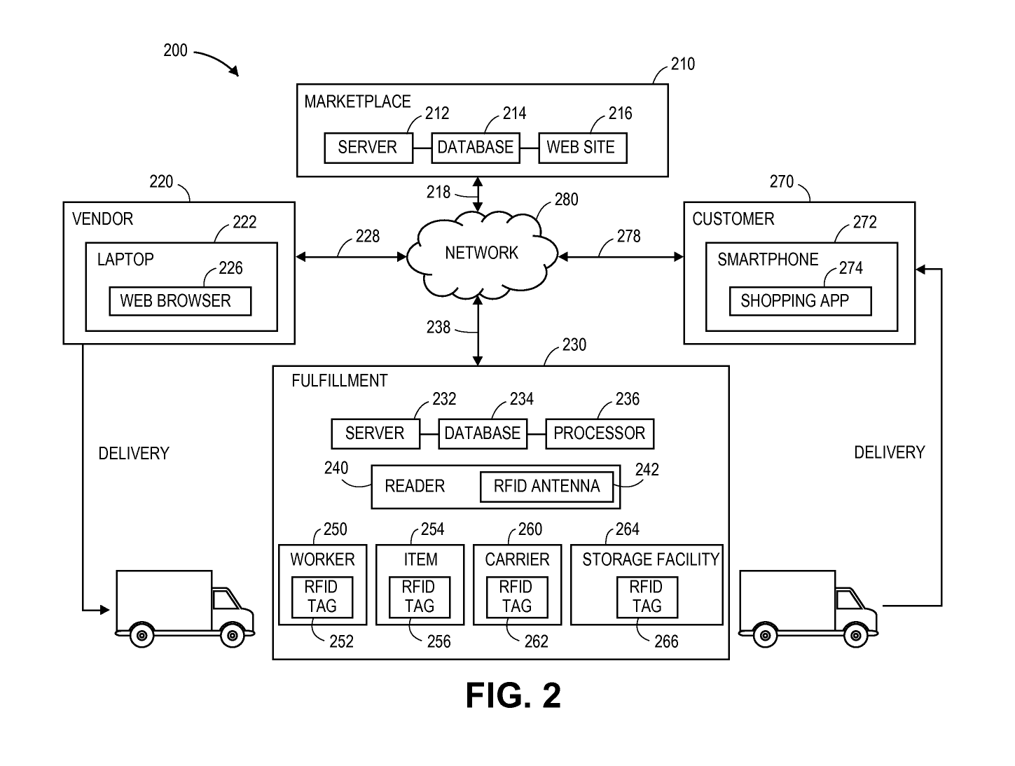

Referring to FIG. 2, a block diagram of one system 200 for tracking transactions by confluences of RFID signals is shown. The system 200 includes a marketplace 210, a vendor 220, a fulfillment center 230 and a customer 270 that are connected to one another across a network 280, such as the Internet.

The marketplace 210 may be any entity or individual that wishes to make items from a variety of sources available for download, purchase, rent, lease or borrowing by customers using a networked computer infrastructure, including one or more physical computer servers 212 and databases (or other data stores) 214 for hosting a web site 216. The marketplace 210 may be physically or virtually associated with one or more storage or distribution facilities, such as the fulfillment center 230. The web site 216 may be implemented using the one or more servers 212, which connect or otherwise communicate with the one or more databases 214 as well as the network 280, as indicated by line 218, through the sending and receiving of digital data. Moreover, the database 214 may include any type of information regarding items that have been made available for sale through the marketplace 210, or ordered by customers from the marketplace 210.

The vendor 220 may be any entity or individual that wishes to make one or more items available to customers, such as the customer 270, by way of the marketplace 210. The vendor 220 may operate one or more order processing and/or communication systems using a computing device such as a laptop computer 222 and/or software applications such as a web browser 226, which may be implemented through one or more computing machines that may be connected to the network 280, as is indicated by line 228, in order to transmit or receive information regarding one or more items to be made available at the marketplace 210, in the form of digital or analog data, or for any other purpose.

The vendor 220 may deliver one or more items to one or more designated facilities maintained by or on behalf of the marketplace 210, such as the fulfillment center 230. Additionally, the vendor 220 may receive one or more items from other vendors, manufacturers or sellers (not shown), and may deliver one or more of such items to locations designated by the marketplace 210, such as the fulfillment center 230, for fulfillment and distribution to customers. Furthermore, the vendor 220 may perform multiple functions. For example, the vendor 220 may also be a manufacturer and/or a seller of one or more other items, and may offer items for purchase by customers at venues (not shown) other than the marketplace 210. Additionally, items that are made available at the marketplace 210 or ordered therefrom by customers may be made by or obtained from one or more third party sources, other than the vendor 220, or from any other source (not shown). Moreover, the marketplace 210 itself may be a vendor, a seller or a manufacturer.

The fulfillment center 230 may be any facility that is adapted to receive, store, process and/or distribute items. As is shown in FIG. 2, the fulfillment center 230 includes a networked computer infrastructure for performing various computer-related functions associated with the receipt, storage, processing and distribution of such items, including one or more physical computer servers 232, databases (or other data stores) 234 and processors 236. The fulfillment center 230 may also include stations for receiving, storing and distributing items to customers, such as one or more receiving stations, storage areas and distribution stations. The fulfillment center 230 further includes at least one RFID reader 240 having an antenna 242.

The RFID reader 240 is any type of sensor or interrogator that may be provided for use in connection with signals transmitted from one or more active or passive RFID tags. The RFID reader 240 may include one or more components for transmitting or receiving signals, such as the antenna 242, as well as various circuitry components for processing and controlling the operation of the RFID reader 240. Additionally, the RFID reader 240 may communicate with RFID tags by way of any coupling modes or methods that may be known to those of ordinary skill in the pertinent arts. For example, an RFID tag may modulate one or more elements of the data stored thereon, and transmit a modulated data signal to a receiving circuit associated with the RFID reader 240. Subsequently, the RFID reader 240 may then demodulate the data signal, and provide a processed set of data derived from the data signal to the server 232 or another computer for further processing.

Moreover, the RFID reader 240 may be configured to capture, evaluate, transmit or store any available information regarding signals received from one or more RFID tags, including information regarding any attributes of the signals, including but not limited to sensed signal strengths or intensities, angular directions or ranges to the RFID tags from which such signals were received, any differences between the strengths, intensities, angular orientations or ranges associated with two or more signals, or information or data included in the signals. Although the fulfillment center 230 of FIG. 2 includes a single RFID reader 240, those of ordinary skill in the pertinent arts will recognize that any number of RFID readers 240 may be provided throughout a fulfillment center environment, and in any number of specified stations or locations, in accordance with the present disclosure.

As is also shown in FIG. 2, the fulfillment center 230 also includes at least one worker 250, at least one item 254, at least one item carrier 260 and at least one storage facility 264. The worker 250 may be any designated personnel tasked with performing one or more tasks within the fulfillment center 230, and may wear, carry or otherwise be associated with or adorned with an RFID tag 252. The worker 250 may handle or transport items within the fulfillment center 230, operate one or more pieces of equipment therein (not shown). The worker 250 may also operate one or more specific computing devices or machines for registering the receipt, retrieval, transportation or storage of items within the fulfillment center 230, or a general purpose device such a personal digital assistant, a digital media player, a smartphone, a tablet computer, a desktop computer or a laptop computer (not shown), which may include any form of input and/or output peripherals such as scanners, readers, keyboards, keypads, touchscreens or like devices.

The item 254 may be any type or form of good, product, media or other tangible consumer article that may be received at, stored in or distributed from the fulfillment center 230. As is shown in FIG. 2, the item 254 has an RFID tag 256 mounted to, embedded therein or otherwise associated therewith. The item carrier 260 may be any form of vessel or facility for transporting an item from one location to another within the fulfillment center 230, such as a bin, a tote, a cart or another like device. As is also shown in FIG. 2, the item carrier 260 has an RFID tag 262 mounted to or otherwise associated therewith. The item carrier 260 may include any type or form of handles, hooks, bars or grips for carrying or pushing the item carrier 260 throughout the fulfillment center 230, and may be further provided with wheels, rails, sliders or other like components that enable the item carrier 260 to be transported throughout the fulfillment center 230 with ease. Alternatively, the item carrier 260 may be a motorized and/or self-guided robotic cart that may be programmed to automatically travel to and between various points within the fulfillment center 230.

The storage facility 264 may be any two-dimensional or three-dimensional space or structure for accommodating items and/or containers of such items within the fulfillment center 230, such as aisles, rows, bays, shelves, slots, bins, racks, tiers, bars, hooks, cubbies or other like storage means, or any other appropriate regions or stations. As is shown in FIG. 2, the storage facility 264 has an RFID tag 266 mounted to or otherwise associated therewith. The storage facility 264 may be fixed or mobile, e.g., associated with a wheeled component such as a self-powered or motorized cart.

The fulfillment center 230 may operate one or more order processing and/or communication systems using computer devices in communication with one or more of the server 232, the database 234 and/or the processor 236, or through one or more other computing devices or machines that may be connected to the network 280, as is indicated by line 238, in order to transmit or receive information in the form of digital or analog data, or for any other purpose. Such computer devices may also operate or provide access to one or more reporting systems for receiving or displaying information or data regarding workflow operations, and may provide one or more interfaces for receiving interactions (e.g., text, numeric entries or selections) from one or more operators, users or workers in response to such information or data. Such computer devices may be general purpose devices or machines, or dedicated devices or machines that feature any form of input and/or output peripherals such as scanners, readers, keyboards, keypads, touchscreens or like devices, and may further operate or provide access to one or more engines for analyzing the information or data regarding the workflow operations, or the interactions received from the one or more operators, users or workers.

Additionally, as is discussed above, the fulfillment center 230 may include one or more receiving stations featuring any apparatuses that may be required in order to receive shipments of items at the fulfillment center 230 from one or more sources and/or through one or more channels, including but not limited to docks, lifts, cranes, jacks, belts or other conveying apparatuses for obtaining items and/or shipments of items from carriers such as cars, trucks, trailers, freight cars, container ships or cargo aircraft (e.g., manned aircraft or unmanned aircraft, such as drones), and preparing such items for storage or distribution to customers. The fulfillment center 230 may also include one or more predefined two-dimensional or three-dimensional storage areas including facilities, such as the storage facility 264, for accommodating items and/or containers of such items, such as aisles, rows, bays, shelves, slots, bins, racks, tiers, bars, hooks, cubbies or other like storage means, or any other appropriate regions or stations. The fulfillment center 230 may further include one or more distribution stations where items that have been retrieved from a designated storage area may be evaluated, prepared and packed for delivery from the fulfillment center 230 to addresses, locations or destinations specified by customers, also by way of carriers such as cars, trucks, trailers, freight cars, container ships or cargo aircraft (e.g., manned aircraft or unmanned aircraft, such as drones).

Moreover, the fulfillment center 230 may further include one or more control systems that may generate instructions for conducting operations at the fulfillment center 230, and may be in communication with the RFID reader 240, the worker 250, the items 254, the item carriers 262, or the various storage facilities 264 at the fulfillment center 230. Such control systems may also be associated with one or more other computing devices or machines, and may communicate with the marketplace 210, the vendor 220 or the customer 270 over the network 280, as indicated by line 238, through the sending and receiving of digital data.

The customer 270 may be any entity or individual that wishes to download, purchase, rent, lease, borrow or otherwise obtain items (e.g., goods, products, services or information of any type or form) from the marketplace 210. The customer 270 may utilize one or more computing devices, such as a smartphone 272 or any other like machine that may operate or access one or more software applications, such as a web browser (not shown) or a shopping application 274, and may be connected to or otherwise communicate with the marketplace 210, the vendor 220 or the fulfillment center 230 through the network 280, as indicated by line 278, by the transmission and receipt of digital data. Moreover, the customer 270 may also receive deliveries or shipments of one or more items from facilities maintained by or on behalf of the marketplace 210, such as the fulfillment center 230, or from the vendor 220.

The computers, servers, devices and the like described herein have the necessary electronics, software, memory, storage, databases, firmware, logic/state machines, microprocessors, communication links, displays or other visual or audio user interfaces, printing devices, and any other input/output interfaces to provide any of the functions or services described herein and/or achieve the results described herein. Also, those of ordinary skill in the pertinent art will recognize that users of such computers, servers, devices and the like may operate a keyboard, keypad, mouse, stylus, touch screen, or other device (not shown) or method to interact with the computers, servers, devices and the like, or to “select” an item, link, node, hub or any other aspect of the present disclosure.

Those of ordinary skill in the pertinent arts will understand that process steps described herein as being performed by a “marketplace,” a “vendor,” a “fulfillment center,” a “worker,” or a “customer,” or like terms, may be automated steps performed by their respective computer systems, or implemented within software modules (or computer programs) executed by one or more general purpose computers. Moreover, process steps described as being performed by a “marketplace,” a “vendor,” a “fulfillment center,” a “worker,” or a “customer” may be typically performed by a human operator, but could, alternatively, be performed by an automated agent.

The marketplace 210, the vendor 220, the fulfillment center 230, the worker 250, and/or the customer 270 may use any web-enabled or Internet applications or features, or any other client-server applications or features including electronic mail (or E-mail), or other messaging techniques, to connect to the network 280 or to communicate with one another, such as through short or multimedia messaging service (SMS or MMS) text messages. For example, the server 232 may be adapted to transmit information or data in the form of synchronous or asynchronous messages from the fulfillment center 230 to the server 212, the laptop computer 222, a desktop computer, the smartphone 272 or any other computer device in real time or in near-real time, or in one or more offline processes, via the network 280. Those of ordinary skill in the pertinent art would recognize that the marketplace 210, the vendor 220, the fulfillment center 230, the worker 250 or the customer 270 may operate any of a number of computing devices that are capable of communicating over the network, including but not limited to set-top boxes, personal digital assistants, digital media players, web pads, laptop computers, desktop computers, electronic book readers, and the like. The protocols and components for providing communication between such devices are well known to those skilled in the art of computer communications and need not be described in more detail herein.

The data and/or computer executable instructions, programs, firmware, software and the like (also referred to herein as “computer executable” components) described herein may be stored on a computer-readable medium that is within or accessible by computers or computer components such as the server 212, the laptop computer 222, the server 232, or the smartphone 272, or any other computers or control systems utilized by the marketplace 210, the vendor 220, the fulfillment center 230, the worker 250 or the customer 270 and having sequences of instructions which, when executed by a processor (e.g., a central processing unit, or “CPU”), cause the processor to perform all or a portion of the functions, services and/or methods described herein. Such computer executable instructions, programs, software and the like may be loaded into the memory of one or more computers using a drive mechanism associated with the computer readable medium, such as a floppy drive, CD-ROM drive, DVD-ROM drive, network interface, or the like, or via external connections.

Some embodiments of the systems and methods of the present disclosure may also be provided as a computer executable program product including a non-transitory machine-readable storage medium having stored thereon instructions (in compressed or uncompressed form) that may be used to program a computer (or other electronic device) to perform processes or methods described herein. The machine-readable storage medium may include, but is not limited to, hard drives, floppy diskettes, optical disks, CD-ROMs, DVDs, ROMs, RAMs, erasable programmable ROMs (“EPROM”), electrically erasable programmable ROMs (“EEPROM”), flash memory, magnetic or optical cards, solid-state memory devices, or other types of media/machine-readable medium that may be suitable for storing electronic instructions. Further, embodiments may also be provided as a computer executable program product that includes a transitory machine-readable signal (in compressed or uncompressed form). Examples of machine-readable signals, whether modulated using a carrier or not, may include, but are not limited to, signals that a computer system or machine hosting or running a computer program can be configured to access, or including signals that may be downloaded through the Internet or other networks.

Although some of the embodiments disclosed herein reference the use of RFID readers and RFID tags in a fulfillment center environment, and the use of RFID tags that are worn by workers, mounted to items or associated with equipment (e.g., item carriers or storage facilities) within the fulfillment center environment, the systems and methods are not so limited. Rather, the systems and methods disclosed herein may be utilized in any environment in which information regarding a physical transaction involving multiple discrete actors or entities must be captured, evaluated or stored, and are particularly useful in environments in which such information must be captured, evaluated or stored relatively quickly, and with a high degree of accuracy, including but not limited to environments in which traditional power supplies are not reliable or may not be readily accessed.

As is discussed above, the systems and methods of the present disclosure are directed to tracking transactions based on confluences of RFID signals, including a predetermined set of RFID signals that are received simultaneously or nearly simultaneously, e.g., at the same time, or within a predetermined time interval of one another, by an RFID reader from a defined set of RFID sources. When such signals are received, a transaction may be defined, and information regarding the transaction may be captured and stored in at least one data store, and subject to further processing.

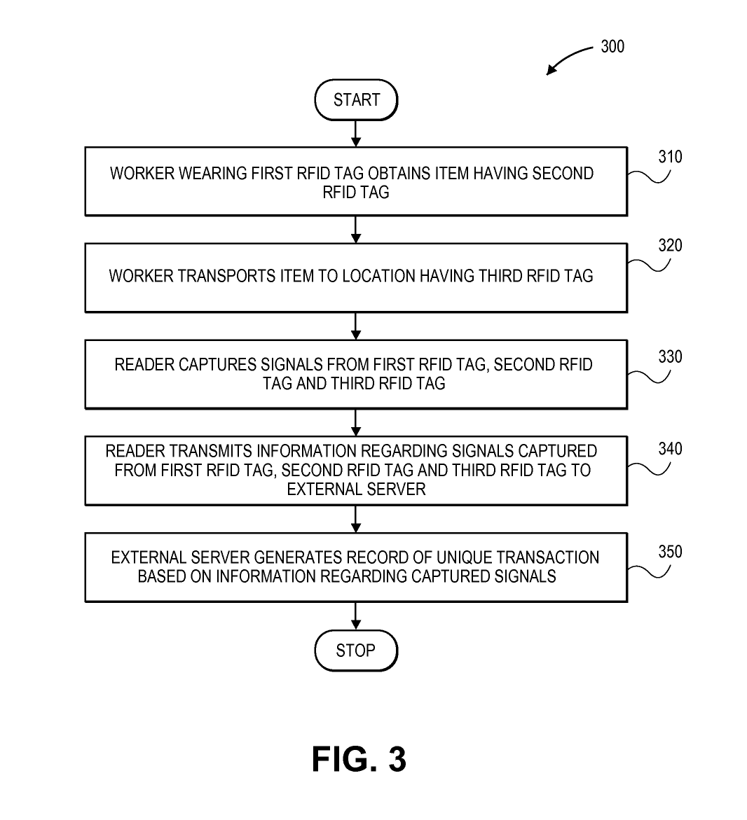

Referring to FIG. 3, a flow chart 300 representing one embodiment of a process for tracking transactions by confluences of RFID signals is shown. At box 310, a worker wearing a first RFID tag obtains an item having a second RFID tag. The worker may wear the first RFID tag anywhere on his or her person, including on his belt, such as the RFID tag 152 on the worker 150 of FIG. 1, or on any other portion of his or her body or clothing, such as a shirt, a pair of pants, a pair of shoes, a hat or a pair of gloves or other accessory. The item may have the second RFID tag mounted or otherwise adhered thereto, e.g., in the form of a label, or embedded in an external surface of the item or a container having the item therein.

At box 320, the worker transports the item to a location having a third RFID tag. The location may be a bin, a tote, a cart or any other form of item carrier, such as the item carrier 260 of FIG. 2, or an aisle, a row, a bay, a shelf, a slot, a bin, a rack, a tier, a bar, a hook, a cubby or other like storage means, or a predetermined region of a fulfillment center, such as the storage facility 264 of FIG. 2. The third RFID tag may be mounted in a convenient position at the location, e.g., directly to an item carrier or storage facility, or in a vicinity of the item carrier or the storage facility. At box 330, an RFID reader captures signals from the first RFID tag, the second RFID tag and the third RFID tag. For example, when each of the RFID tags associated with the worker, the item and the location is within range of an RFID reader that generates a magnetic or electric field, the tags may be coupled with the RFID reader, thereby causing data signals to be transmitted from the associated RFID tags to the RFID reader, which may capture such signals on a simultaneous or nearly-simultaneous basis.

At box 340, the reader transmits information regarding the signals captured from the first RFID tag, the second RFID tag and the third RFID tag to an external server. Referring again to FIG. 2, the RFID reader 240 may transmit such information to the server 232 that resides or is associated with the fulfillment center 230, or to another server, e.g., the marketplace server 212, over the network 280. At box 350, the external server to which the information regarding the signals from the first RFID tag, the second RFID tag and the third RFID tag is transmitted generates a record of a unique transaction based on such information, and the process ends. The unique transaction may include any relevant information identifying at least one of the worker, the item or the location, as well as a time or date at which the signals were received from the first RFID tag, the second RFID tag and the third RFID tag, and/or an identifier associated with the RFID reader.

Accordingly, the systems and methods of the present disclosure may identify and store information regarding a transaction, i.e., a concurrent interaction between one or more entities bearing RFID tags, including but not limited to objects, humans, machines or structures. When one or more RFID readers simultaneously or nearly simultaneously captures signals from such RFID tags, information regarding the RFID tags, the entities to which the RFID tags are affixed, or any other relevant information (e.g., a time or date at which the signals are transmitted by the RFID tags or received from the RFID tags, or a location or identifier of the RFID readers that received such signals) may be generated by the RFID reader or another associated computer component and stored in at least one data store. Such information may be used for any relevant purpose, such as to update a status of an object, a human, a machine or a structure to which an RFID tag is affixed, in real time or in near-real time, or for a review or an audit of transactions involving the object, the human, the machine or the structure at a later time. Because RFID tags are generally known to precisely and efficiently transmit their respective data signals promptly when entering within a range of a corresponding electric or magnetic field provided by an RFID reader, the information that is generated and stored based on such signals regarding a transaction may be considered to have a higher degree of confidence and reliability as to the exact times and dates of the transaction, or the entities that participated in the transaction.

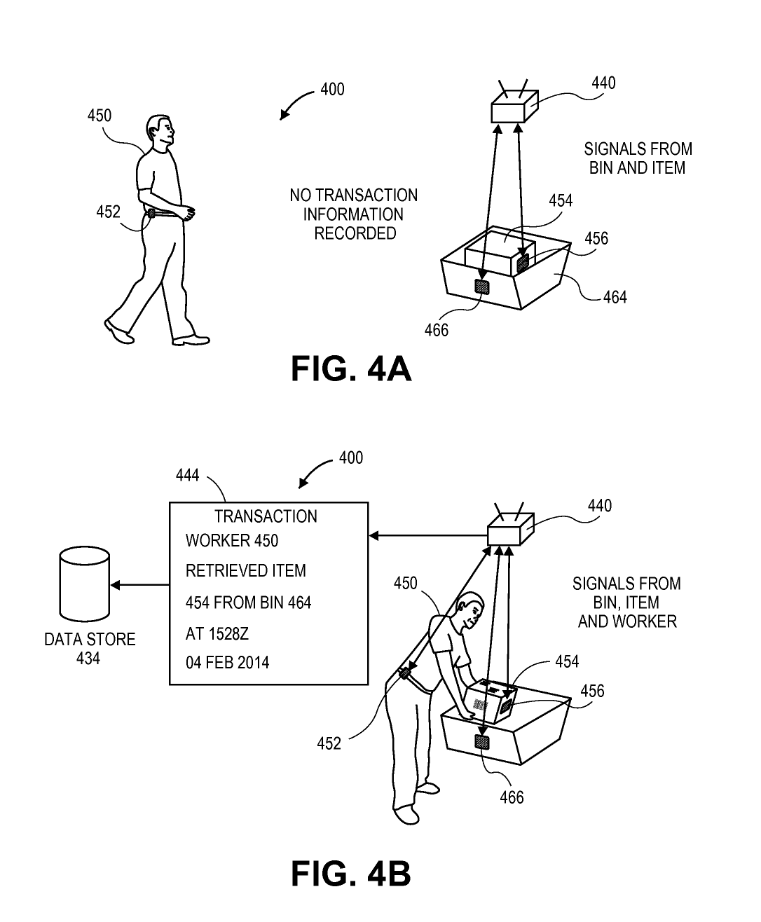

The detection of a confluence of RFID signals from a predetermined combination of RFID tags, and the generation and transmission of information related to such signals in accordance with some embodiments of the present disclosure, are shown with regard to FIGS. 4A and 4B. Referring to FIG. 4A, views of one system 400 for tracking transactions by confluences of RFID signals is shown. Except where otherwise noted, reference numerals preceded by the number “4” in FIG. 4A or 4B indicate components or features that are similar to components or features having reference numerals preceded by the number “2” shown in FIG. 2, or by the number “1” shown in FIG. 1.

The system 400 of FIG. 4A includes an RFID reader 440, a worker 450, an item 454 and a storage facility 464. The worker 450 is shown as approaching the storage facility 464 while wearing an RFID tag 452. The item 454 is deposited in the storage facility 464, and also includes an RFID tag 456 affixed to an external surface. The storage facility 464 also has an RFID tag 466 affixed to an external surface.

As is shown in FIG. 4A, no information regarding a transaction is recorded, because the worker 450 is not within a range of the RFID reader 440. Although the item 454 and the storage facility 464 are within range of the RFID reader 440, and the RFID reader 440 receives signals from the RFID tag 456 affixed to the item 454, and from the RFID tag 466 affixed to the storage facility 464, no information regarding a transaction is recorded in the absence of the worker 450.

Referring to FIG. 4B, the system 400 of FIG. 4A is shown, with the worker 450 retrieving the item 454 from the storage facility 464. As is shown in FIG. 4B, the worker 450 is within a range of the RFID reader 440, thereby causing a signal to be transmitted from the RFID tag 452 to the RFID reader 440 and received simultaneously or nearly simultaneously, e.g., at the same time, or within a predetermined time interval of one another, with signals transmitted from the RFID tags 456, 466 to the RFID reader 440. Once such signals are received by the RFID reader 440, the RFID reader 440 may then transmit information 444 (viz., an identity of the worker 450 and the item 454, as well as the time and date at which the item 454 was retrieved from the storage facility 464) regarding the transaction to the data store 434, where such information 444 may be stored and recalled for further processing or evaluation in the future.

As is discussed above, the systems and methods of the present disclosure may be provided for the purpose of virtually confirming the occurrence of a physical transaction based on a confluence of RFID signals received by one or more RFID readers. The confluence of such signals may be determined by comparing various attributes of such signals, including but not limited to their strengths or intensities, their angular or radial separation, or the information or data included in such signals, in order to confirm that an appropriate and relevant confluence of signals is received and confirmed. In this regard, particularly in noisy or active environments involving large numbers of entities bearing RFID tags, the precision and efficiency of such systems may be enhanced by determining not only that such signals are received simultaneously or nearly simultaneously, e.g., at the same time, or within a predetermined time interval of one another, but also that such signals are sufficiently linked with one another to thereby constitute a transaction for which relevant information should be captured and stored.

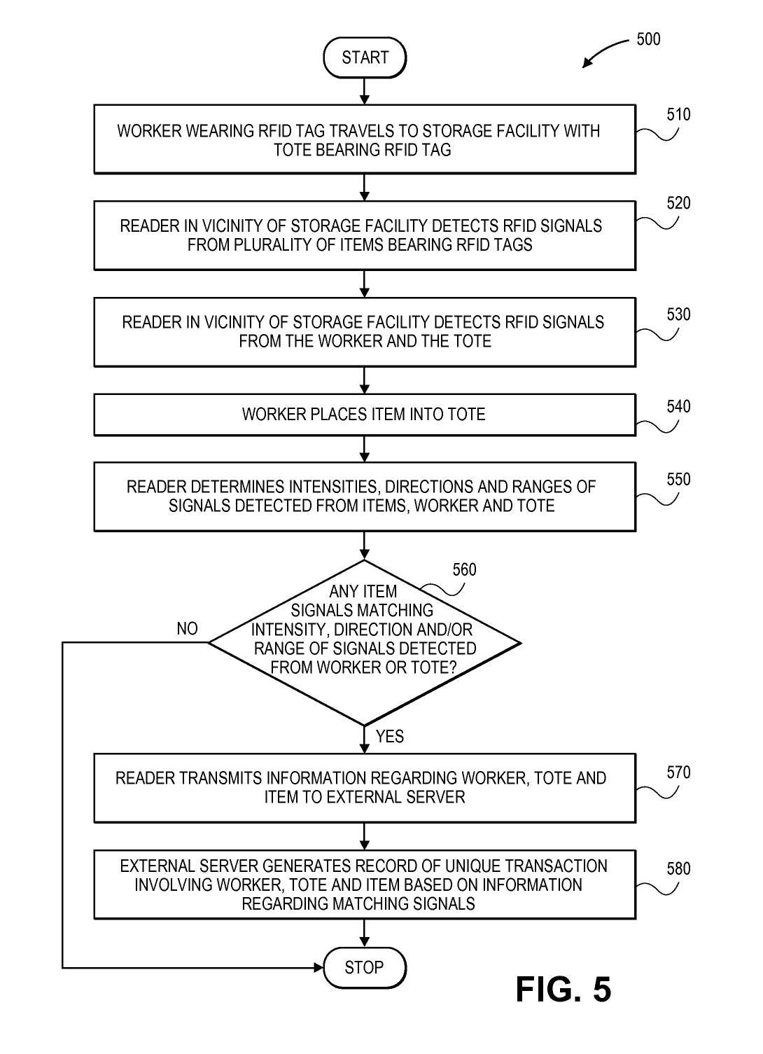

Referring to FIG. 5, a flow chart 500 representing one embodiment of a process for tracking transactions by confluences of RFID signals is shown. At box 510, a worker wearing an RFID tag travels to a storage facility with a tote that is also bearing an RFID tag. The worker may have been provided with instructions to retrieve one or more items from the storage facility in order to transport such items to a distribution station in preparation for delivery to a customer, or to perform any other pertinent task.

At box 520, a reader in a vicinity of the storage facility detects RFID signals from a plurality of items bearing RFID tags, and at box 530, the reader also detects RFID signals from the RFID tags associated with the worker and the tote. For example, a stationary RFID reader mounted in a defined region of a fulfillment center may be configured to generate magnetic fields or electric fields having predetermined strengths or polarities, and any appropriately configured (e.g., inductively coupled or capacitively coupled) RFID tags within an operational range of the RFID reader may generate data signals in response to such fields. Such signals may be captured and interpreted by the RFID reader upon their receipt.

At box 540, the worker places one of the items into the tote, and at box 550, the reader determines the intensities, directions and ranges of RFID signals received from the worker, the tote and the various items at the storage facility. A determination as to the attributes of such signals may be quantitative or qualitative in nature. For example, a range may be determined with specificity and assigned a numeric value, e.g., 5.2 meters, or determined in a binary nature, e.g., greater than 5 meters or less than five meters. Similarly, a value of an intensity of an RFID signal received from an RFID tag may be objectively determined, or may be comparatively determined against the intensities of RFID signals received from other RFID tags, or a threshold capacity of the RFID reader.

At box 560, whether any of the RFID signals received from items matches the intensities, the directions and/or the ranges of the RFID signals detected from the worker and the tote is determined. For example, by comparing attributes such as intensities, directions or ranges of signals received not only from the RFID tags associated with the worker or the tote but also from the various RFID tags provided throughout the storage facility, or the content of such signals, the RFID reader may determine which of the items is in close proximity to the worker and/or the tote, thereby suggesting that the worker placed the item into the tote, and which of the items remains at the storage facility.

If none of the RFID signals received from the items matches the RFID signals received from the worker and the tote in terms of attributes such as intensity, direction, range or signal content, then it may be presumed that the worker has not placed any of the items into the tote, and the process ends. However, if the attributes of any of the RFID signals received from such items, e.g., an intensity, a direction, a range or signal content, matches the attributes of the RFID signals received from the worker and the tote, then the process advances to box 570, where the reader transmits information regarding the worker, the tote and the item to an external server. For example, referring again to FIG. 4B, information 444 regarding the worker 450, the item 454 and the storage facility 464 may be transmitted from the RFID reader 440 to the data store 434. Such information 444 may identify the dates and times at which such signals were received, and the worker 450, the item 454 and the storage facility 464 from which the signals were received, or include any other related data. At box 580, the external server generates a record of a unique transaction involving the worker, the tote and the item from which the matching RFID signals were received, and the process ends. For example, the record may include at least some of the information received from the RFID reader, as well as any other information relating to the unique transaction that may be required or desired, and the record may be utilized for any relevant purpose at a later time.

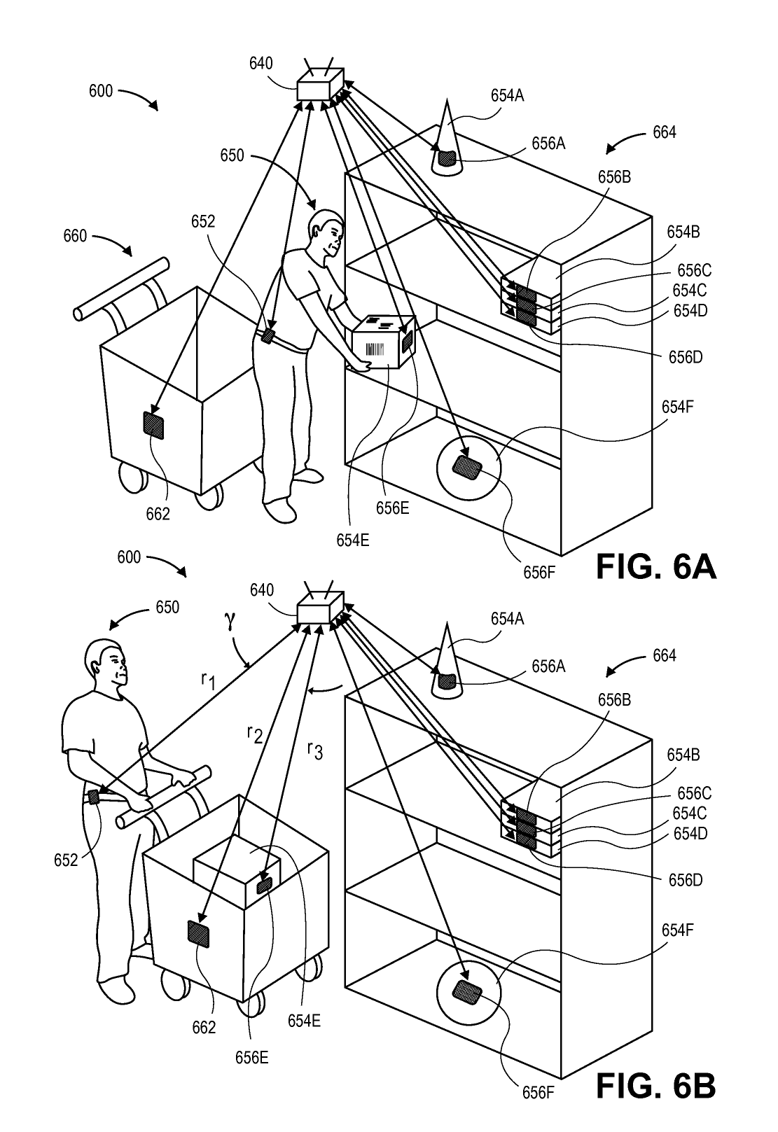

A determination of a confluence of RFID signals based on their respective attributes, such as intensities, angular orientations, angular separations, ranges or signal content, is shown with regard to FIGS. 6A and 6B. Referring to FIG. 6A, views of one system 600 for tracking transactions by confluences of RFID signals is shown. Except where otherwise noted, reference numerals preceded by the number “6” in FIG. 6A or 6B indicate components or features that are similar to components or features having reference numerals preceded by the number “4” shown in FIG. 4A or 4B, by the number “2” shown in FIG. 2, or by the number “1” shown in FIG. 1.

The system 600 includes an RFID reader 640, a worker 650, a storage facility 664 having a plurality of items 654A, 654B, 654C, 654D, 654E, 654F therein and an item carrier 660 (viz., a cart). The worker 650 is wearing an RFID tag 652 about his or her waist (e.g., on a belt) and is shown as retrieving the item 654E from the storage facility 664. Each of the items 654A, 654B, 654C, 654D, 654E, 654F includes an RFID tag 656A, 656B, 656C, 656D, 656E, 656F affixed thereto. The item carrier 660 also has an RFID tag 662 affixed thereto.

As is shown in FIG. 6A, the RFID reader 640 receives a variety of data signals from the RFID tags 652, 656A, 656B, 656C, 656D, 656E, 656F, 662. The RFID signals are received from a widely distributed spread with respect to one another, including signals received from the RFID tag 662 on the left, from the RFID tag 652 in the middle and from the RFID tags 656A, 656B, 656C, 656D, 656E, 656F on the right. Because the RFID reader 640 may capture signals from a variety of items 654A, 654B, 654C, 654D, 654E, 654F at the storage facility 664, determining which of the items 654A, 654B, 654C, 654D, 654E, 654F is participating in a transaction including the worker 650 and the item carrier 660, and which of the items 654A, 654B, 654C, 654D, 654E, 654F will remain in the storage facility 664, is difficult.

Referring to FIG. 6B, the system 600 of FIG. 6A is shown, with the item 654E within the item carrier 660. Additionally, as is also shown in FIG. 6B, the RFID signals are shown as being transmitted from the RFID tag 652 on the worker 650, the RFID tag 662 on the item carrier 660 and the RFID tag 656E on the item 654E within a substantially narrow degree of angular separation y and at substantially similar ranges r₁, r₂ and r₃. Meanwhile, none of the RFID signals that are received by the RFID reader 640 from the RFID tags 656A, 656B, 656C, 656D, 656F on the other items 654A, 654B, 654C, 654D, 654F has a similar range or is approximately co-aligned with either of the RFID signals transmitted from the RFID tag 652 or the RFID tag 662.

Therefore, because the RFID signal received from the RFID tag 656E on the item 654E is received from a similar axis or at a similar range to the RFID signals received from the RFID tag 652 on the worker 650 and the RFID tag 662 on the item carrier 660, information regarding a transaction involving the worker 650, the item 654E and the item carrier 660 may be captured by the RFID reader 640 and stored in at least one data store. Such information may identify the worker 650, the item 654E and/or the item carrier 660, as well as a time or a date when the item 654E was retrieved from the storage facility 664, or any other relevant information regarding the transaction.

Alternatively, some embodiments of the present disclosure may utilize an RFID reader (not shown) provided within the item carrier 660, which may be configured to detect RFID signals transmitted from short ranges, and may therefore distinguish a given item within the item carrier 660 from other items on the storage facility 664. Furthermore, an identification of a specific item may be determined based on extrinsic information. For example, where the worker 650 is instructed to retrieve a plurality of items in a predetermined order or according to a list, and a plurality of RFID signals are received from a variety of items, information regarding a transaction involving a specific item that is next in the order or on the list may be captured or stored once a confluence of RFID signals including an RFID signals from an RFID device associated with the specific item is received.

As is discussed above, an RFID signal may be transmitted from an RFID tag to an RFID reader when the RFID tag is coupled to the RFID reader, and such a coupling may be accomplished according to any number of modes, including but not limited to inductive coupling, capacitive coupling, magnetic coupling or backscatter coupling. Moreover, a coupling of an RFID tag and an RFID reader may occur automatically, i.e., once the RFID tag is present within a magnetic field, an electric field or another field of energy emitted by the RFID reader, or manually when a worker or a machine (e.g., an autonomous mobile robot) contacts an external surface of a manually activated RFID tag, thereby closing a circuit within the RFID tag and causing an RFID signal to be transmitted to the RFID reader. Thus, a transaction may be defined, and information regarding the transaction may be recorded, when an RFID reader that is already coupled with (e.g., receiving a data signal from) an RFID tag becomes coupled with a manually activated RFID tag, and receives a data signal from the manually activated RFID tag, as well. A manually activated RFID tag may be provided in association with a worker, an object (e.g., an item), a carrier, a storage facility or any other element or feature.

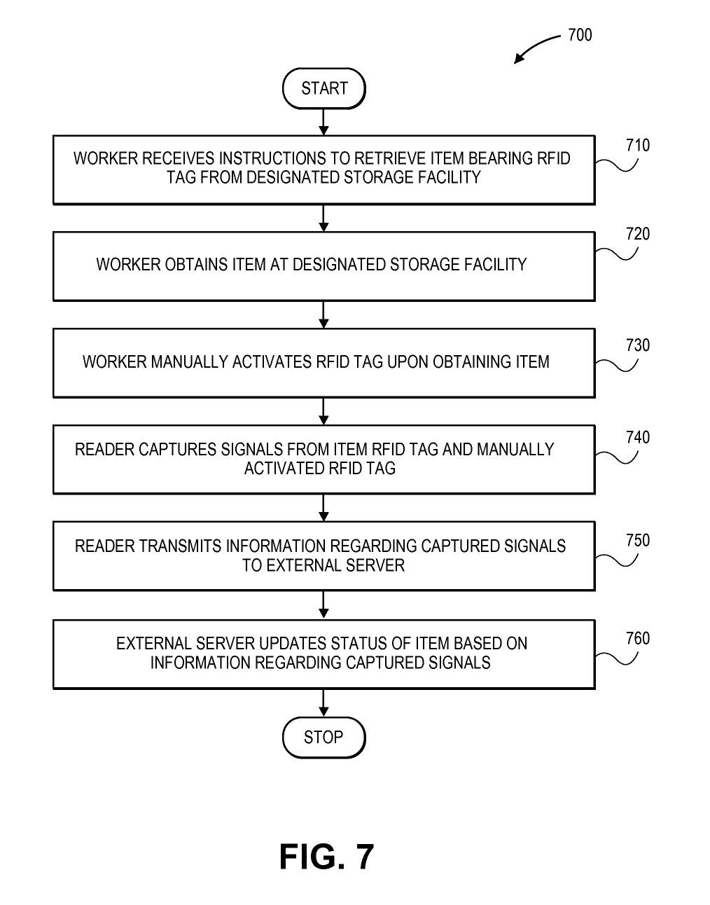

Referring to FIG. 7, a flow chart 700 representing one embodiment of a process for tracking transactions by confluences of RFID signals is shown. At box 710, a worker receives instructions to retrieve an item bearing an RFID tag from a designated storage facility. The instructions may identify the item and a location or apparatus within the storage facility (e.g., a shelf, a rack, a tier, a bar, a hook or another storage means) where the item is believed to be stored. At box 720, the worker obtains the item at the designated storage facility, such as by physically retrieving the item from the location or apparatus where the item is stored.

At box 730, the worker manually activates an RFID tag upon obtaining the item. The manually activated RFID tag may be associated with the worker (e.g., worn on a belt, arm, hand, wrist or other body part or accessory of the worker), or mounted to a bin, a tote or a cart into which the item is deposited, or to the location or the apparatus from which the item was obtained. At box 740, an RFID reader captures a signal from the RFID tag on the item and a signal from the manually activated RFID tag. The RFID reader may be configured to receive RFID signals of any intensity or frequency, and at any range, as may be required by the application for which the RFID reader is provided. At box 750, the RFID reader transmits information regarding the captured signals to an external server. For example, referring again to the system 200 of FIG. 2, the RFID reader 240 may transmit the information to the server 232 at the fulfillment center 230, or to the marketplace server 212 or another computer component over the network 280. Such information may identify not only the item to which the RFID is mounted but also the worker, item carrier, location or apparatus with which the manually activated RFID tag is associated, as well as a time at which the signals were captured by the RFID reader, a location of the RFID reader, or any other relevant data.

At box 760, the external server updates a status of the item based on the information regarding the captured signals, and the process ends. For example, where a transaction indicates that an item has arrived at a receiving station, has been deposited in a storage facility, has been retrieved from a storage facility, has been transported to a distribution station in preparation for delivery, or has been subject to any other action or motion, the status of the item may be updated based on the information regarding the transaction. The status update may be defined by a quantitative or objective identification such as a location of the item, e.g., a name or an identifier of the physical location of the item at a time of the transaction, or by a qualitative or objective statement as to the status of the item, e.g., that the item is “arrived,” “in transit,” “being stowed,” “in storage,” “being retrieved,” “prepared for delivery,” “departed” or the like.

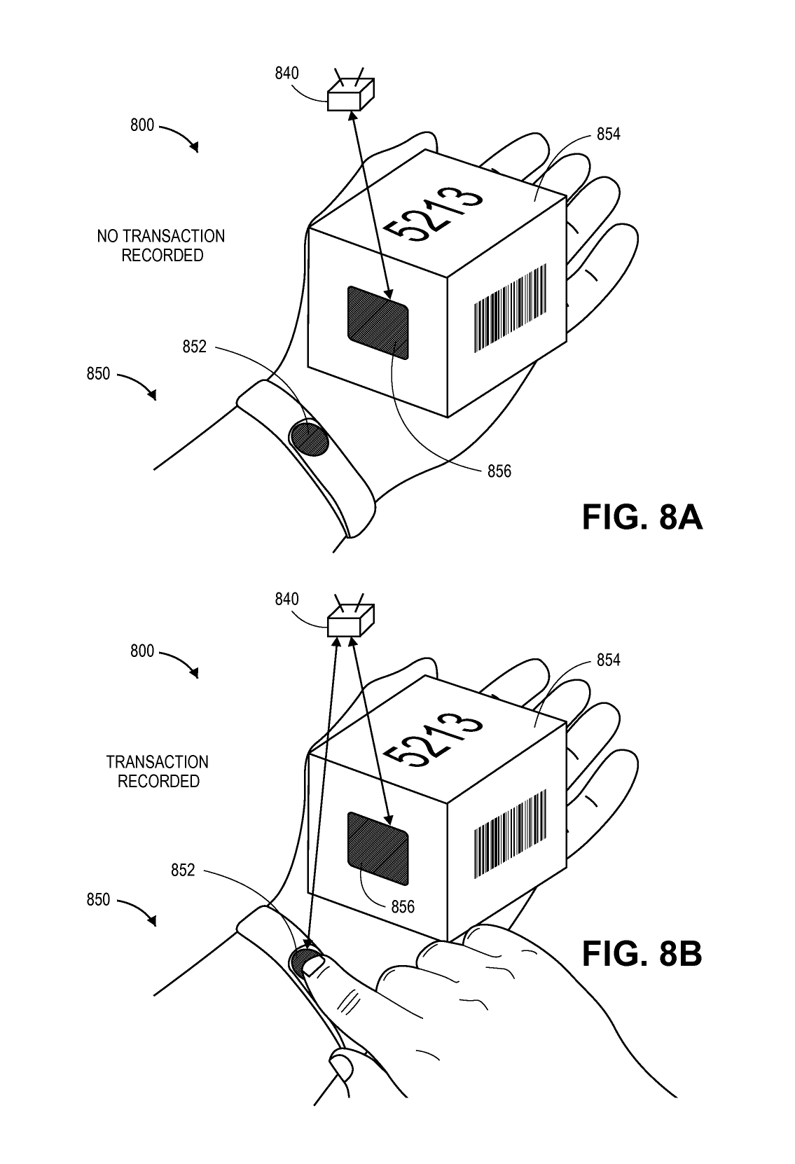

As is discussed above, a manually activated RFID tag may be provided in association with an object, a human, a machine or a structure. A manually activated RFID tag may be provided in any manner, including attached to one or more objects, humans, machines or structures, and may therefore be activated in the presence of an RFID reader, and in a vicinity of one or more additional RFID tags, in order to create a confluence of RFID signals that may be sensed by the RFID reader in order to cause information regarding a transaction to be recorded. Referring to FIGS. 8A and 8B, views of one system 800 for tracking transactions by confluences of RFID signals is shown. Except where otherwise noted, reference numerals preceded by the number “8” in FIG. 8A or 8B indicate components or features that are similar to components or features having reference numerals preceded by the number “6” shown in FIG. 6A or 6B, by the number “4” shown in FIG. 4A or 4B, by the number “2” shown in FIG. 2, or by the number “1” shown in FIG. 1.

The system 800 of FIG. 8A includes an RFID reader 840 and a worker 850 who is holding an item 854. The worker 850 is wearing a manually activated RFID tag 852 about his or her wrist, and the item 854 also includes a standard passive RFID tag 856. As is shown in FIG. 8A, when the manually activated RFID tag 852 about the wrist of the worker 850 is not activated, the RFID reader 840 senses an RFID signal from the RFID tag 856 affixed to the item 854 alone, and no information regarding a transaction is recorded.

As is shown in FIG. 8B, however, when the worker 850 activates the manually activated RFID tag 852, e.g., by contacting a portion of the RFID tag 852 that may include one or more capacitive elements, thereby closing a circuit within the RFID tag 852, an RFID signal may be transmitted from the RFID tag 852 to the RFID reader 840. Because the RFID reader 840 also senses a signal from the RFID tag 854 on the item 856, information regarding a transaction involving the worker 850 and the item 854, viz., a time or date at which the RFID signals are sensed, as well as an identity of the worker 850 and/or the item 854, or a location of the RFID reader 840, is captured and recorded.

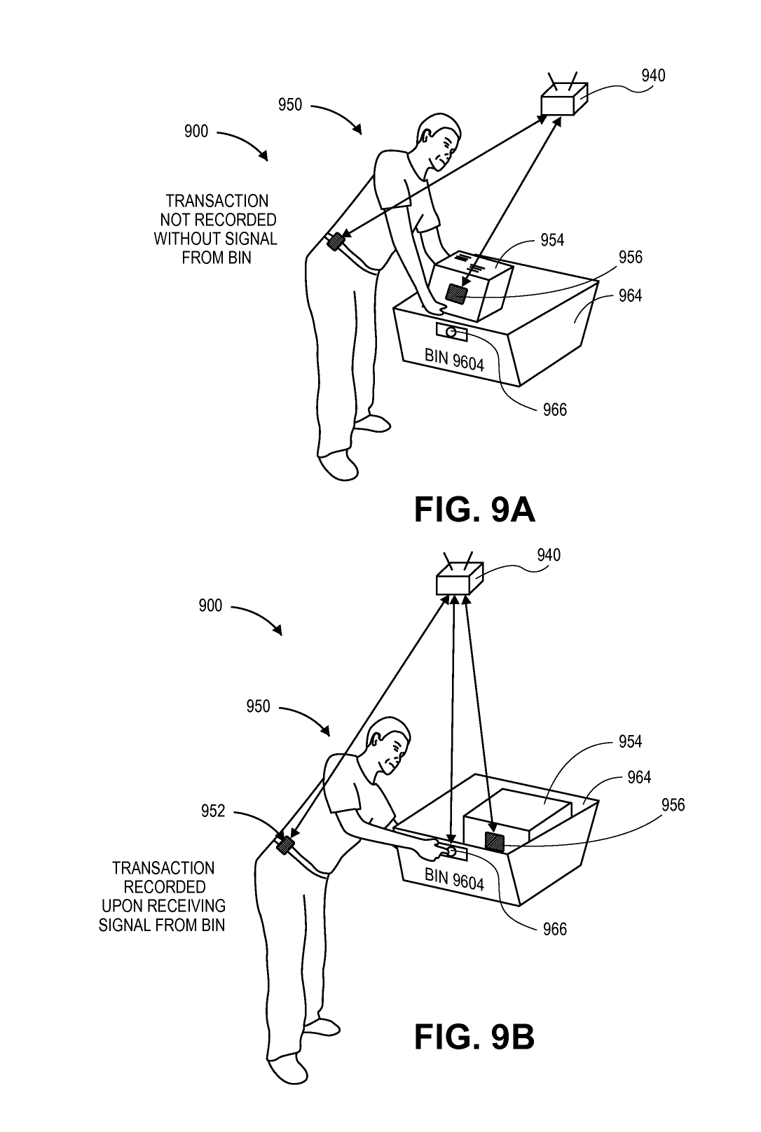

As is discussed above, manually activated RFID tags may be provided not only on clothing of a worker, or an accessory worn by the worker, but also on objects, machines or structures. Referring to FIGS. 9A and 9B, views of one system 900 for tracking transactions by confluences of RFID signals is shown. Except where otherwise noted, reference numerals preceded by the number “9” in FIG. 9A or 9B indicate components or features that are similar to components or features having reference numerals preceded by the number “8” shown in FIG. 8A or 8B, by the number “6” shown in FIG. 6A or 6B, by the number “4” shown in FIG. 4A or 4B, by the number “2” shown in FIG. 2, or by the number “1” shown in FIG. 1.

The system 900 of FIG. 9A includes an RFID reader 940 and a worker 950 who is placing an item 954 into a storage facility 964 (e.g., a bin). The worker 950 is wearing a standard passive RFID tag 952, and the item 954 also includes a standard passive RFID tag 956. The storage facility 964 further includes a manually activated RFID tag 966 mounted on an exterior surface.

As is shown in FIG. 9A, when the worker 950 deposits the item 954 into the storage facility 964, the RFID reader 940 receives RFID signals from the RFID tag 952 on the worker 950, and from the RFID tag 956 on the item 954, but not from the manually activated RFID tag 966 on the storage facility 964. Accordingly, no information regarding a transaction is recorded.

As is shown in FIG. 9B, however, after the worker 950 has deposited the item 954 into the storage facility 964, and contacted the manually activated RFID tag 966, an RFID signal is transmitted from the RFID tag 966 to the RFID reader 940. When the RFID reader 940 senses the RFID signal from the RFID tag 966 on the storage facility 964, as well as the signals from the RFID tag 952 on the worker 950 and the RFID tag 956 on the item 954, however, information regarding a transaction involving the worker 950, the item 954 and the storage facility 964, e.g., indicating that the item 954 has been deposited by the worker 950 into the storage facility 964, may be captured by the RFID reader 940 and stored or transmitted to one or more external servers or data stores.

Therefore, information regarding a transaction involving multiple entities, e.g., objects, humans, machines or structures, having RFID tags associated therewith may be captured and stored based on a confluence of RFID signals in accordance with the present disclosure, and one or more of such RFID signals may be transmitted following a manual activation of one or more of the RFID tags, such as is shown in FIGS. 8B and 9B. Such RFID tags may be activated based on bioelectricity provided by a worker, contact between two or more conductive plates within an RFID tag initiated by the worker, or in any other manner in accordance with the present disclosure.

Although the disclosure has been described herein using exemplary techniques, components, and/or processes for implementing the present disclosure, it should be understood by those skilled in the art that other techniques, components, and/or processes or other combinations and sequences of the techniques, components, and/or processes described herein may be used or performed that achieve the same function(s) and/or result(s) described herein and which are included within the scope of the present disclosure. For example, although some of the embodiments of the present disclosure are shown as being utilized in a fulfillment center environment, e.g., with RFID tags provided on workers at a fulfillment center, or on objects, machines or structures within the fulfillment center, the systems and methods disclosed herein are not so limited, and may be provided in connection with objects, humans, machines or structures in any environment, including but not limited to autonomous mobile robots.

It should be understood that, unless otherwise explicitly or implicitly indicated herein, any of the features, characteristics, alternatives or modifications described regarding a particular embodiment herein may also be applied, used, or incorporated with any other embodiment described herein, and that the drawings and detailed description of the present disclosure are intended to cover all modifications, equivalents and alternatives to the various embodiments as defined by the appended claims. Moreover, with respect to the one or more methods or processes of the present disclosure described herein, including but not limited to the flow charts shown in FIGS. 3, 5 and 7, the order in which the boxes or steps of the methods or processes are listed is not intended to be construed as a limitation on the claimed inventions, and any number of the boxes or steps can be combined in any order and/or in parallel to implement the methods or processes described herein. Also, the drawings herein are not drawn to scale.

Conditional language, such as, among others, “can,” “could,” “might,” or “may,” unless specifically stated otherwise, or otherwise understood within the context as used, is generally intended to convey in a permissive manner that certain embodiments could include, or have the potential to include, but do not mandate or require, certain features, elements and/or boxes or steps. In a similar manner, terms such as “include,” “including” and “includes are generally intended to mean “including, but not limited to.” Thus, such conditional language is not generally intended to imply that features, elements and/or boxes or steps are in any way required for one or more embodiments or that one or more embodiments necessarily include logic for deciding, with or without user input or prompting, whether these features, elements and/or boxes or steps are included or are to be performed in any particular embodiment.

Although the invention has been described and illustrated with respect to exemplary embodiments thereof, the foregoing and various other additions and omissions may be made therein and thereto without departing from the spirit and scope of the present disclosure.

What is claimed is:

1. An information recording system comprising:
an RFID reader;
a first RFID tag associated with a human;
a second RFID tag associated with an object; and
a computing device in communication with the RFID reader,
wherein the computing device is configured to implement one or more services, and
wherein the one or more services are configured to:
receive, at the RFID reader, a first RFID signal from the first RFID tag at a first time;
receive, at the RFID reader, a second RFID signal from the second RFID tag at substantially the first time;
define a transaction based at least in part on information regarding at least two of the human, the object, the RFID reader, the first RFID signal or the second RFID signal at the first time; and
store at least some of the information in at least one data store.

2. The information recording system of claim 1, further comprising a third RFID tag associated with a storage facility,
wherein the one or more services are further configured to:
receive, at the RFID reader, a third RFID signal from the third RFID tag at substantially the first time,
wherein the transaction is defined based at least in part on the third RFID signal.

3. The information recording system of claim 2, wherein at least one of the first RFID tag, the second RFID tag or the third RFID tag is manually activated.

4. The information recording system of claim 1, wherein the one or more services are further configured to:
identify an attribute of the first RFID signal, wherein the attribute of the first RFID signal is at least one of a direction of the first RFID signal, a strength of the first RFID signal, an intensity of the first RFID signal, a range of the first RFID signal or information included in the first RFID signal;
identify an attribute of the second RFID signal, wherein the attribute of the second RFID signal is at least one of a direction of the second RFID signal, a strength of the second RFID signal, an intensity of the second RFID signal, a range of the second RFID signal or information included in the second RFID signal; and
determine whether the attribute of the first RFID signal corresponds to the attribute of the second RFID signal.

5. The information recording system of claim 1, wherein the one or more services are further configured to:
transmit the at least some of the information to an external server.

6. A method comprising:
identifying a first signal transmitted by a first RFID device at a first time;
identifying a second signal transmitted by a second RFID device within a predetermined interval associated with the first time;
defining a transaction based at least in part on the first signal and the second signal; and
storing information regarding the transaction in at least one data store, wherein at least some of the information is associated with at least one of the first signal, the first RFID device, the second signal, the second RFID device or the first time.

7. The method of claim 6, wherein identifying the first signal transmitted by the first RFID device at the first time comprises:
receiving the first signal at an RFID reader; and
wherein identifying the second signal transmitted by the second RFID device within the predetermined interval associated with the first time comprises:
receiving the second signal at the RFID reader.

8. The method of claim 6, further comprising:
identifying a third signal transmitted by a third RFID device within the predetermined interval associated with the first time;
determining whether a confluence of signals comprising the first signal, the second signal and the third signal is anticipated within the predetermined interval associated with the first time,
upon determining that the confluence of signals comprising the first signal, the second signal and the third signal is anticipated within the predetermined interval associated with the first time,
defining the transaction based at least in part on the third signal,
wherein at least some of the information regarding the transaction is associated with at least one of the third signal or the third RFID device.

9. The method of claim 6, wherein the first RFID device is associated with at least one of a human, an object, a machine or a structure.

10. The method of claim 6, wherein the first RFID device is associated with at least one of a worker or an autonomous mobile robot within a fulfillment center, and
wherein the second RFID device is associated with at least one of an item within the fulfillment center, an item carrier within the fulfillment center, a machine within the fulfillment center or a storage facility within the fulfillment center.

11. The method of claim 10, wherein the second RFID device is associated with the item within the fulfillment center, and
wherein the method further comprises:
determining a status of the item based at least in part on the transaction; and
storing information regarding the status of the item in the at least one data store.

12. The method of claim 11, wherein the status is at least one of arrived, in transit, being stowed, in storage, being retrieved, prepared for delivery or departed.

13. The method of claim 6, wherein the first RFID device is inductively coupled with an RFID reader at the first time.

14. The method of claim 6, wherein the first signal is transmitted following a manual activation of the first RFID device at the first time.

15. The method of claim 14, wherein the first RFID device comprises an open circuit having at least two capacitive elements separated by an air gap, and
wherein the manual activation closes the open circuit at the first time.

16. The method of claim 6, wherein defining the transaction based at least in part on the first signal and the second signal comprises:
determining a first attribute of the first signal;
determining a second attribute of the second signal; and
defining the transaction based at least in part on the first attribute of the first signal and the second attribute of the second signal.

17. The method of claim 16, wherein the first attribute is at least one of a first angular direction of the first signal, a first range from the first RFID device to an RFID reader, a first intensity of the first signal, a first strength of the first signal or information included in the first signal, and
wherein the second attribute is at least one of a second angular direction of the second signal, a second range from the second RFID device to the RFID reader, a second intensity of the second signal, a second strength of the second signal or information included in the second signal.

18. A non-transitory computer-readable medium having computer-executable instructions stored thereon,
wherein the instructions, when executed, cause a computer system having at least one computer processor to perform a method comprising:
receiving, in response to a manual activation of a first RFID tag, a first RFID signal from the first RFID tag at a first time;
identifying a second RFID signal received from a second RFID tag at substantially the first time;
defining a transaction based at least in part on information regarding a first entity associated with the first RFID tag and a second entity associated with the second RFID tag; and
storing at least some of the information in at least one data store.

19. The non-transitory computer-readable medium of claim 18, wherein the first RFID tag comprises an open circuit having at least two capacitive elements separated by an air gap, and
wherein the manual actuation closes the open circuit at the first time.

20. The non-transitory computer-readable medium of claim 18, wherein the method further comprises:
identifying a third RFID signal received from a third RFID tag at substantially the first time,
wherein the transaction is defined based at least in part on information regarding a third entity associated with the third RFID tag.
